(19) United States
(12) Patent Application Publication
(10) Pub. No.: US 2026/0370085 A1
(43) Pub. Date: Nov. 19, 2026

(54) DRIVE ASSEMBLY FOR DRIVING A MOTOR VEHICLE AS WELL AS TOOL AND METHOD FOR DISASSEMBLING THE DRIVE ASSEMBLY

(71) Applicant: GKN Automotive Limited, Birmingham (GB)

(72) Inventors: Alexander Feichter, Bruneck (IT); Christian Daporta, Bruneck (IT)

(21) Appl. No.: 19/673,421

(22) Filed: May 11, 2026

(30) Foreign Application Priority Data
May 13, 2025 (DE) 102025118384.8

(51) Int. Cl. H02K 7/00; H02K 7/116

(52) U.S. Cl. CPC H02K 7/003; H02K 7/006; H02K 7/116

(57) ABSTRACT

A drive assembly for a motor vehicle, having a housing; a motor shaft, a planetary gearing in the housing and including a sun gear, a ring gear, planet gears and a planet carrier. The sun gear is formed integrally with a connecting shaft which is inserted into the hollow motor shaft and is rotatably drivable by the hollow shaft about an axis. The ring gear is held in the housing in a rotationally fixed manner and the connecting shaft is connected to the hollow shaft in a rotationally fixed manner and is axially fixed by a circlip which engages in an inner circumferential groove of the hollow shaft. The hollow shaft has, in axial overlap with the inner circumferential groove, at least six radial bores distributed circumferentially about the axis of rotation, through which elements of a disassembly tool can act on the circlip in order to loosen it.

### CROSS REFERENCE TO RELATED APPLICATIONS

This application claims priority to German Patent Application No. 102025118384.8 filed on May 13, 2025, and the content of this priority application is incorporated herein by reference in its entirety.

### TECHNICAL FIELD

The disclosure relates to a drive assembly for driving a motor vehicle as well as a tool and a method for disassembling the drive assembly.

### BACKGROUND

An important issue in the manufacture of such drive assemblies is the final quality control, also known as end-of-line testing. If, for example, a gearbox or a motor of the drive assembly does not meet the specified quality criteria, it may be necessary to replace defective components or assemblies. Disassembly of the drive assembly may not be possible in a non-destructive manner, meaning that the drive assembly would have to be disposed of as a faulty product.

DE 10 2018 110 879 A1 shows an assembly for securing the axial position of a sun gear of a planetary gearing stage on a rotor shaft of an electrical machine. The sun gear has an end section that is stepped radially outward on the inner diameter and is axially secured on the rotor shaft by means of at least one securing ring. To secure against the centrifugal forces, at least one securing sleeve is provided, which is inserted into the end section on the sun gear for fastening and is at least partially pushed over the securing ring. In the area of a 90° curvature at the attachment of the angled end section of the securing sleeve, several openings are provided evenly distributed over the circumference. The openings are designed as radial through bores into which a pulling tool can engage on the inner diameter of the securing sleeve to pull the securing sleeve out of the sun gear.

A device for detaching snap rings is known from JP H09 - 303 355 A. US 2014 / 0 196 796 A1 discloses an assembly for an electrically operated valve in the automotive field aimed to increase the injection pressure of fuel in combustion chambers. Planetary gearings are known from US 3 021 731 A and CN 1 06 931 101 A. WO 2020 / 063 920 A1 and DE 10 2013 217 950 A1 show planetary gearings for a wind turbine.

An object of at least some implementations of the present disclosure is to provide a drive assembly for driving a motor vehicle which enables the drive assembly to be quickly and easily disassembled.

### SUMMARY

A drive assembly for driving a motor vehicle is proposed. Further embodiments of the drive assembly are given in the dependent claims.

The radial bores distributed on the hollow shaft circumferentially about the axis of rotation enable elements of a disassembly tool that can be arranged on the hollow shaft to be positioned quickly and easily. Due to the axial overlap of the radial bores of the inner circumferential groove, the elements of the disassembly tool can act on the circlip to loosen it from the hollow shaft and remove the connecting shaft with the sun gear from the hollow shaft. Accordingly, a defective drive assembly can be disassembled non-destructively, quickly and easily during quality control or maintenance.

The drive assembly is designed for driving a motor vehicle. For this purpose, the drive assembly has a motor shaft that is rotationally drivable in the housing about the axis of rotation of the electric machine. The motor shaft is designed as a hollow shaft. An electric machine for driving the hollow shaft can be arranged in the housing.

A planetary gearing, also known as an epicyclic gear, is a gearbox with several gears. The planetary gearing includes the sun gear, the ring gear held in the housing in a rotationally fixed manner and several planet gears rotatably mounted on the planet carrier. The ring gear can be held on a ring gear carrier in a rotationally fixed manner in the housing. The sun gear is integrally designed with a connecting shaft. The connecting shaft is inserted into the hollow shaft and is rotationally drivable by the hollow shaft about the axis of rotation. In this context, inserted can be understood to mean that the connecting shaft is arranged in an interior space of the hollow shaft via an axial longitudinal section. The interior space of the hollow shaft can be defined by an inner wall surface of a wall.

The connecting shaft is connected to the hollow shaft in a rotationally fixed manner and axially fixed by the circlip. The circlip engages in the inner circumferential groove of the hollow shaft. In this context, the inner circumferential groove can be understood as a groove running circumferentially about the axis of rotation on an inner wall surface of the hollow shaft for sectional accommodation of the circlip. The circlip can be arranged on the connecting shaft in an outer circumferential groove. Furthermore, the circlip can have an axial width of between 1 mm and 4 mm, or between 2 mm and 3 mm.

The radial bores can be formed on the hollow shaft at equal distances from each other circumferentially about the axis of rotation. Radial bores can be understood as openings that penetrate the wall of the hollow shaft from an outer wall surface to an inner wall surface and are aligned radially to the axis of rotation. The diameter of the radial bores can be dimensioned in such a way that the inner circumferential groove is axially overlapped by the cross-section of the radial bores. In other words, the diameter of a radial bore can at least correspond to the width of the inner circumferential groove or be greater than the width of the inner circumferential groove in the axial direction. The diameter of the radial bores can be larger than a width of the circlip and/or a width of the inner circumferential groove in order to enable complete overlap of the inner circumferential groove and/or the circlip in the axial direction of the axis of rotation. Furthermore, the radial bores may be designed identically. In addition, the radial bores can be arranged with their bore axes in a plane that can be perpendicular to the axis of rotation.

The connecting shaft can have a circumferential recess located axially adjacent to the circlip or the outer circumferential groove for the circlip. The recess can be designed in the axial direction of the axis of rotation on one or both sides adjacent to the circlip or the outer circumferential groove, respectively. The recess can be understood as a section of the connecting shaft extending in the axial direction of the axis of rotation, which has a smaller diameter than at least the remainder of the connecting shaft that is inserted into the hollow shaft. The circumferential recess can have a depth of between 0.025 mm and 2 mm or between 0.05 mm and 1 mm. The recess makes it even easier and more reliable for the circlip to be fully compressed in the direction of the axis of rotation by the elements of the disassembly tool.

The circlip can be arranged axially between an end face of the hollow shaft and a bearing by which the hollow shaft is mounted in the housing. The term end face can be understood to refer to the face at the end of the hollow shaft. The end face can be arranged perpendicular to the axis of rotation. The bearing can be axially secured in the housing by a circlip. The bearing can also be designed as a roller bearing, for example a ball bearing, although other bearing variants are also possible.

The hollow shaft can have, in axial direction starting from the end face, a sleeve section and a toothed section adjoining the sleeve section, which toothed section connects the hollow shaft to the connecting shaft in a rotationally fixed manner. The sleeve section can be understood as a section of the hollow shaft extending in the axial direction of the axis of rotation. Similarly, a sleeve section can also designate such a section of the connecting shaft. The toothed section is designed such that the hollow shaft and the connecting shaft are connected to each other circumferentially about the axis of rotation in a rotationally fixed manner. The toothed section can be designed so that the hollow shaft and the connecting shaft can be adjusted relative to each other in the axial direction to the axis of rotation when the circlip is missing or compressed by the elements of a disassembly tool. For example, a spline, such as a spline gear, can be formed on the toothed section, in which the connecting shaft has external teeth and the hollow shaft has internal teeth.

A clearance fit can be formed between the sleeve section of the hollow shaft and the connecting shaft. The clearance fit can be designed in such a way that the connecting shaft can be pulled out of the hollow shaft with a tool or manually by a user if the circlip is missing or compressed by the elements of the disassembly tool. The clearance fit can be designed as an Hx/hy fit, for example H6/h6. By forming a clearance fit between the sleeve section of the hollow shaft and the connecting shaft, it is easy to ensure that the connecting shaft can be separated from the hollow shaft quickly and non-destructively without great effort.

The number of radial bores or disassembly elements is selected so that the circlip can be elastically deformed radially inwards over the entire circumference out of the inner circumferential groove of the hollow shaft, so that the connecting shaft together with the circlip can be pulled out of the hollow shaft. As few as six radial bores may be sufficient to allow reliable action on the circlip during disassembly of the sun gear. It is understood that a larger number of, for example, at least seven, eight, nine or more radial bores or elements is also possible. In particular, the hollow shaft can have eight radial bores distributed circumferentially about the axis of rotation and arranged in axial overlap with the inner circumferential groove. The radial bores can be evenly distributed around the circumference of the hollow shaft. Eight radial bores allow the circlip to be compressed more evenly, minimizing the risk of jamming between the circlip and the inner wall surface of the hollow shaft.

The outer diameter of the sun gear can be smaller than the outer diameter of a shaft end of the hollow shaft arranged facing the sun gear. The outer diameter of the sun gear can be understood as the tip diameter of the sun gear. The shaft end of the hollow shaft can be a section of the hollow shaft extending from the end face of the hollow shaft to a bearing seat or the bearing arranged on the bearing seat. Interacting positioning means can be provided between the shaft end and the tool about which the tool can be easily aligned with the shaft end of the hollow shaft. The positioning means can, for example, comprise a recess in the outer wall surface of the hollow shaft and a positioning element in the form of a protrusion that can engage in the recess. As the outer diameter of the sun gear is smaller than the outer diameter of the shaft end of the hollow shaft, a ring-shaped disassembly tool can be easily and quickly slid over the sun gear onto the shaft end of the hollow shaft.

The connecting shaft can have a shoulder that abuts against the end face of the hollow shaft. The shoulder can be supported on the end face of the hollow shaft. The shoulder can have a diameter that is larger than the inner diameter of the inner wall surface and smaller than the outer diameter of the hollow shaft at the shaft end, or smaller than the outer diameter of the sun gear. The shoulder can be arranged in the axial direction to the axis of rotation at a distance from the circlip and/or the inner circumferential groove that corresponds to the distance between the plane and the end face of the hollow shaft. The shoulder makes it easy to ensure the axial position of the circlip relative to the inner circumferential groove and the radial bores.

The disclosure further relates to a tool for disassembling a drive assembly with a ring-shaped base body, for example a ring element, with at least six, seven or eight threaded bores arranged circumferentially about a longitudinal axis, and a number of screws corresponding to the number of threaded bores, which are arranged in the threaded bores so as to be adjustable in a radial direction relative to the longitudinal axis.

The ring-shaped base body can have two axially spaced side surfaces as well as an inner surface and an outer surface arranged at a distance from the inner surface in a radial direction to the longitudinal axis. The screws can be designed as grub screws, for example, although the choice of screws is not limited to this.

The threaded bores can be understood as openings penetrating the base body in a radial direction to the longitudinal axis from the outer surface to the inner surface with an internal thread. The threaded bores can lie with their bore axes in a plane which is perpendicular to the longitudinal axis and which can also be referred to as the actuation plane. The threaded bores can penetrate the center of the base body, i.e. the actuation plane can be arranged on half the width of the base body.

The ring-shaped base body can have a central opening, wherein the inner diameter of the central opening can be larger than the outer diameter of the sun gear, so that the ring-shaped base body can be slid over the sun gear. The inner diameter can be understood as the diameter of the base body on the inner surface.

Depending on the size of the outer diameter of the sun gear, the ring-shaped base body can be integrally formed and/or have two half-ring-shaped sub-elements that can be detachably connected to each other at at least two connection points. The connection points can be arranged between two adjacent radial bores on the base body. The connection points can, for example, be designed as protrusions projecting radially from the outer surface of the base body with openings arranged transverse to the longitudinal axis for the arrangement of a screw-nut connection.

The disclosure also relates to a system comprising a drive assembly described above and a tool described above. The system can have at least one tool. It is also conceivable that the system has a large number of tools with base bodies that have different openings so that a tool can be used flexibly for the drive assembly depending on the size of the sun gear.

Furthermore, the disclosure relates to a method for disassembling the drive assembly using the tool described above. The method has the following steps:
arranging the ring-shaped base body of the tool on the hollow shaft,
aligning the base body relative to the hollow shaft so that the threaded bores are aligned with the radial bores, and
screwing the screws into the radial bores to push the circlip radially inward out of the inner circumferential groove of the hollow shaft and to separate the hollow shaft from the connecting shaft in order to remove the sun gear.

The ring-shaped base body of the tool can be arranged on the shaft end of the hollow shaft. If the central opening has a larger inner diameter than the outer diameter of the sun gear, the base body can be pushed over the sun gear onto the hollow shaft for being arranged on the hollow shaft. In the case of a two-part base body, the two sub-elements can be arranged at the shaft end and connected to each other at the connection points.

The base body can be aligned by a rotational movement around the axis of rotation so that the threaded bores are aligned with the radial bores. Positioning means can be provided to simplify alignment.

As soon as the threaded bores are aligned with the radial bores, the screws can be screwed into the radial bores. The circlip is pressed radially inwards out of the inner circumferential groove of the hollow shaft by the screws, allowing the hollow shaft to be separated from the connecting shaft and adjusted along the longitudinal axis in order to remove the sun gear.

### BRIEF DESCRIPTION OF THE DRAWINGS

Certain embodiments are explained in more detail with reference to the figures. Herein:

FIG. 1 shows a longitudinal cut of a drive assembly for driving a motor vehicle;

FIG. 2 shows a cut-out of the drive assembly of FIG. 1;

FIG. 3 shows a detailed view A of the drive assembly of FIG. 2;

FIG. 4 shows a perspective view of a tool for removing a sun gear of the drive assembly of FIGS. 1-3;

FIG. 5 shows a further detailed view of the drive assembly of FIGS. 1 and 2 with the tool of FIG. 4 arranged and aligned on a hollow shaft of the drive assembly;

FIG. 6 shows a detailed view of the drive assembly of FIG. 5 with a connecting shaft located opposite the hollow shaft during disassembling, and

FIG. 7 shows steps of a method for removing the sun gear of the drive assembly of FIGS. 1, 2, 4 and 5 with the above described tool of FIG. 4.

### DETAILED DESCRIPTION

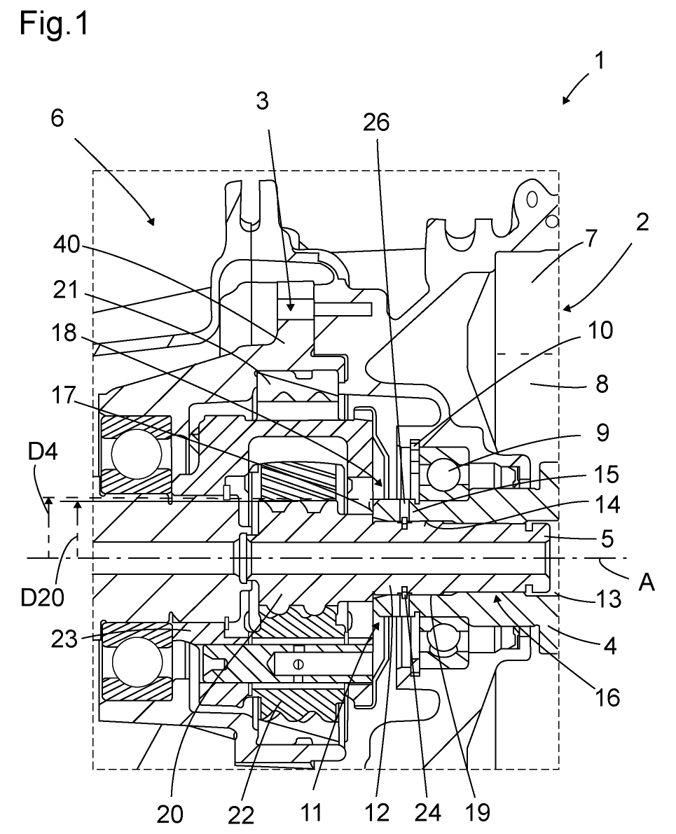

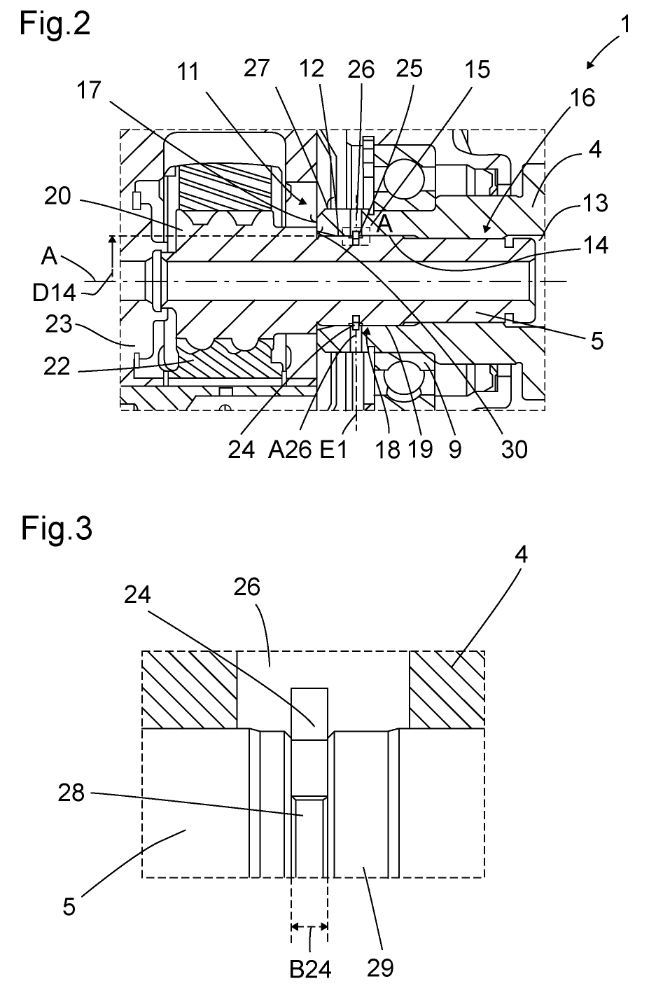

FIGS. 1-6 are described jointly in the following. A drive assembly 1 is shown. The drive assembly 1 comprises an electric machine 2 and planetary gearing 3, which is connected to the electric machine 2 via a motor shaft 4 and a connecting shaft 5. The electric machine 2, the planetary gearing 3 and the shafts 4, 5 are accommodated in a housing 6.

The electric machine 2 serves as a drive source for driving a drive axle of a motor vehicle. The electric machine 2 is controlled by means of power electronics, such as a pulse-controlled inverter, with an integrated electronic control unit (ECU). The electric machine 2 can be connected to a battery (not shown) for the power supply. The electric machine 2 has a stator 7, which is firmly connected to the housing 6, and a rotor 8, which is firmly connected to the motor shaft 4 for Torque Transmission. The electric machine 2 can be used in the form of an asynchronous machine or a synchronous machine.

The motor shaft is designed as a hollow shaft 4 and is rotatably mounted in the housing 6 about an axis of rotation A by bearing means, of which one bearing 9 is shown, and rotatably drivable by the rotor 8. The bearing 9 is axially secured in the housing 6 by a circlip 10. At a shaft end 11 facing the planetary gearing 4, the connecting shaft 5 is inserted into the hollow shaft 4, so that an axial longitudinal section 12 is arranged in an interior space 13 of the hollow shaft 4. The interior space 13 of the hollow shaft 4 is defined by an inner wall surface 14 of a wall 15. The connecting shaft 5 is connected to the hollow shaft 4 in a rotationally fixed manner via a toothed section 16, for example splines, in order to transmit the rotational movement to the planetary gearing 3. A sleeve section 18 is formed between an end face 17 of the hollow shaft 4 and the toothed section 16. A clearance fit 19, for example an H6/h6 fit, can be provided between the sleeve section 18 of the hollow shaft 4 and the connecting shaft 5.

The planetary gearing 3 comprises a sun gear 20, which is formed integrally with the connecting shaft 5, a ring gear 21, which is held in a rotationally fixed manner on a ring gear carrier 40 within the housing 6, several planet gears 22, and a planet carrier 23, on which the planet gears 22 are rotatably mounted and rotate together with it. An outer diameter D20 of the sun gear 20 is smaller than an outer diameter D4 of the hollow shaft 4 at the shaft end 11.

The connecting shaft 5 is axially fixed by means of a circlip 24, which engages in an inner circumferential groove 25 of the hollow shaft 4. The circlip 24 is arranged on the connecting shaft 5 in an outer circumferential groove 28 and has a width B24 with a value between 1 mm and 4 mm, here for example 2 mm and 3 mm. The circlip 24 is arranged in the axial direction between the end face 17 of the hollow shaft 4 and the bearing 9.

The hollow shaft 4 has at least six or seven, in this case eight, radial bores 26 distributed circumferentially about the axis of rotation A in axial overlap with the inner circumferential groove 25. The radial bores 26 are distributed at equal distances from one another circumferentially about the axis of rotation A on the hollow shaft 4 or in the sleeve section 18. Furthermore, the radial bores 26 are designed as openings penetrating the wall 15 of the hollow shaft 4 from the outer wall surface 27 to the inner wall surface 14. Furthermore, the radial bores 26 are identically formed and each have a diameter which is greater than the width B24 of the circlip 24 and a width of the inner circumferential groove 25. The radial bores 26 are arranged with their bore axes A26 in a plane E26 perpendicular to the axis of rotation A.

As shown in detail in FIG. 3, the connecting shaft 5 has a circumferential recess 29 formed axially adjacent to the circlip 24, which is formed next to the outer circumferential groove 28 of the connecting shaft 5. The recess 29 has a smaller diameter than the rest of the connecting shaft 5, which is inserted into the hollow shaft 4. The circumferential recess 29 has a depth of between 0.025 mm and 2 mm.

Additionally, the connecting shaft 5 has a shoulder 30 that abuts against with the end face 17 of the hollow shaft 4. The shoulder 30 has a diameter which has a value between an inner diameter D14 at the inner wall surface 14 and the outer diameter D4 of the hollow shaft 4 at the shaft end 11. The shoulder 30 is arranged at an axial distance from the circlip 24 or the inner circumferential groove 25, which corresponds to the distance between the plane E26 and the end face 17 of the hollow shaft 4.

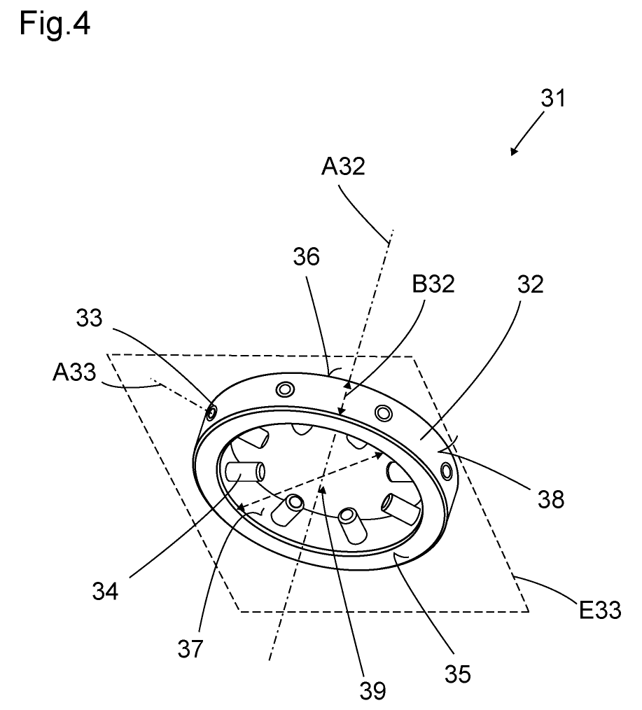

FIG. 4 shows a tool 31 for disassembling the drive assembly 1. The tool 31 has a ring-shaped base body 32 with eight threaded bores 33 distributed circumferentially about a longitudinal axis A32. Furthermore, the tool 31 has eight screws in the form of grub screws 34, which are arranged in the threaded bores 33 to be adjustable in a radial direction relative to the longitudinal axis A32.

The ring-shaped base body 32 has a first side surface 35 and a second side surface 36. Furthermore, the base body 32 has an inner surface 37 and an outer surface 38 arranged at a distance from the inner surface 37 in the radial direction to the longitudinal axis A32, wherein the distance between the first side surface 35 and the second side surface 36 defines the width B32 of the base body 32. The threaded bores 33 are arranged with their bore axes A33 in an actuation plane E33, which is arranged perpendicular to the longitudinal axis A32. The actuation plane E33 can be arranged approximately at a distance from the first side surface 35 that corresponds to the distance of the plane E26 from the bearing 9.

The ring-shaped base body 32 also has a central, circular opening 39. An inner diameter of the central opening 39 is larger than the outer diameter D20 of the sun gear 20. The ring-shaped base body 32 is integrally formed, but according to an embodiment not shown it can also have two half-ring-shaped sub-elements which are detachably connected to each other at at least two connection points.

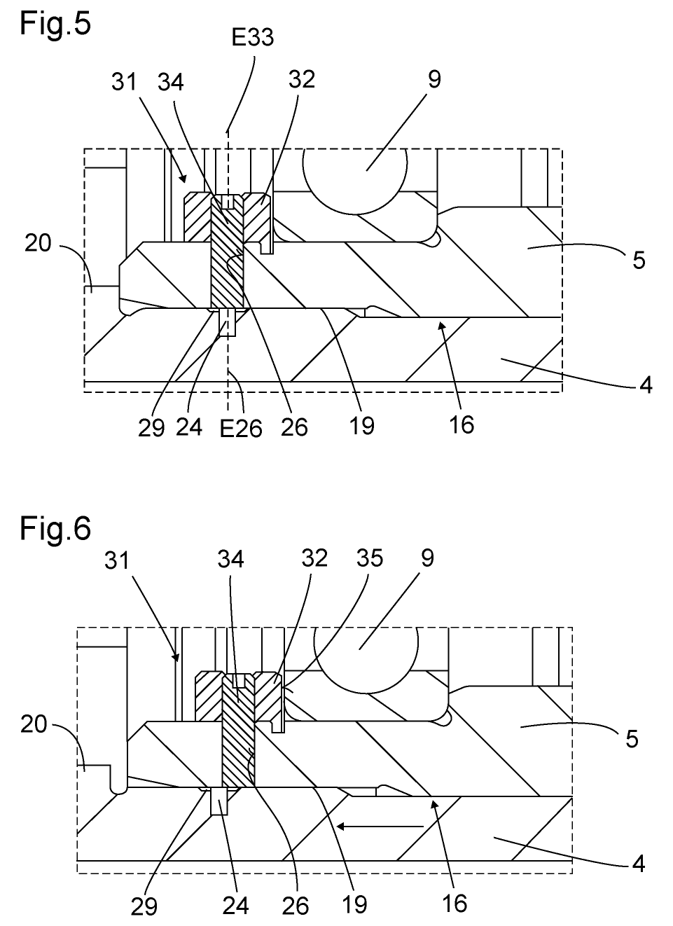

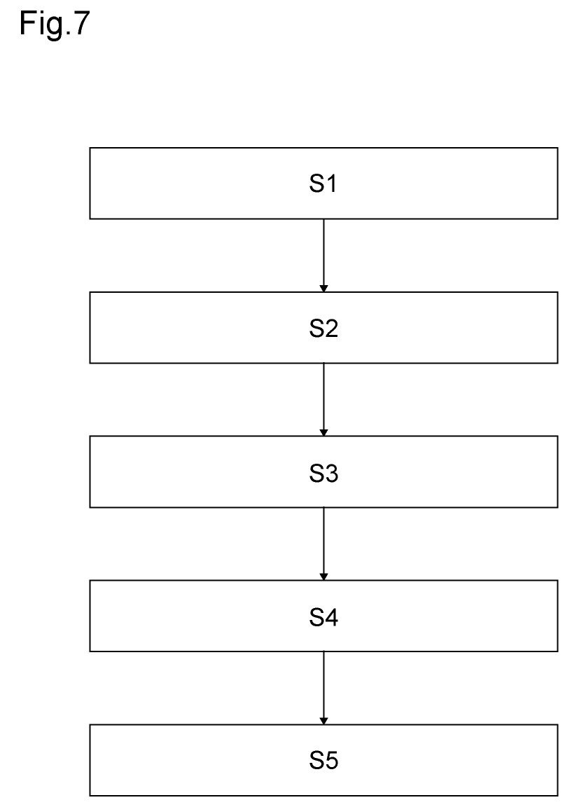

FIG. 7 shows a diagram with steps S1 to S5 of a method for disassembling the drive assembly 1. For removing the sun gear 20, the ring-shaped base body 32 of the tool 31 is arranged on the shaft end 11 of the hollow shaft 4 (S1). The base body 32 is pushed with the central opening 39 over the sun gear 20 onto the hollow shaft 4 and, as shown in FIG. 5, is pushed with the first side surface 35 in the direction of the bearing 9, so that the actuation plane E33 is arranged in the plane E26.

The base body 32 is then aligned relative to the hollow shaft 4 until the threaded bores 33 are aligned with the radial bores 26 (S2). The base body 32 can be aligned by a rotational movement about the axis of rotation A.

As soon as the threaded bores 33 are aligned with the radial bores 26, the grub screws 34 are screwed into the radial bores 26 (S3). The circlip 24 is pressed radially inwards out of the inner circumferential groove 25 of the hollow shaft 4 by the grub screws 34 (S4), whereby the hollow shaft 4 can be separated from the connecting shaft 5 (S5) and adjusted in the direction along the axis of rotation A in order to remove the sun gear 20 with the connecting shaft 5.

By acting on the circlip 24 through the radial bores 26 of the hollow shaft 4 with the grub screws 34 arranged and aligned by means of the tool 31, a defective drive assembly 1 can be disassembled non-destructively, quickly and easily during a quality check or maintenance.

All features explained in connection with individual embodiments of the disclosure can be provided in different combinations for the drive assembly 1, the tool 31 or the method for disassembling the drive assembly 1 in order to realize their advantageous effects, even if these have been described for different embodiments.

1. A drive assembly for driving a motor vehicle, comprising:
a housing;
a motor shaft designed as a hollow shaft, which is rotatably drivable in the housing about an axis of rotation by an electric machine;
a planetary gearing arranged in the housing and including a sun gear, a ring gear, a plurality of planet gears and a planet carrier, wherein the sun gear is formed integrally with a connecting shaft which is inserted into the hollow shaft and is rotatably drivable by the hollow shaft about the axis of rotation, and the ring gear is held in the housing in a rotationally fixed manner;
wherein the connecting shaft is connected to the hollow shaft in a rotationally fixed manner and is axially fixed by a circlip which engages in an inner circumferential groove of the hollow shaft;
wherein the hollow shaft has, in axial overlap with the inner circumferential groove, at least six radial bores distributed circumferentially about the axis of rotation, through which elements of a disassembly tool can act on the circlip in order to loosen it.

2. The drive assembly according to claim 1, wherein the connecting shaft has a circumferential recess located axially adjacent to the circlip.

3. The drive assembly according to claim 1, wherein the circlip is arranged axially between an end face of the hollow shaft and a bearing by which the hollow shaft is mounted in the housing.

4. The drive assembly according to claim 3, wherein the hollow shaft has, in axial direction starting from the end face, a sleeve section and a toothed section adjoining the sleeve section, which toothed section connects the hollow shaft to the connecting shaft in a rotationally fixed manner.

5. The drive assembly according to claim 4, wherein a clearance fit is formed between the sleeve section of the hollow shaft and the connecting shaft.

6. The drive assembly according to claim 1, wherein the hollow shaft has eight radial bores distributed circumferentially about the axis of rotation and arranged in axial overlap with the inner circumferential groove.

7. The drive assembly according to claim 1, wherein the outer diameter of the sun gear is smaller than an outer diameter of a shaft end of the hollow shaft arranged facing the sun gear.

8. The drive assembly according to claim 1, wherein the connecting shaft has a shoulder that abuts against the end face of the hollow shaft.

9. The drive assembly according to claim 1, wherein a diameter of the radial bores is greater than a width of the circlip and/or the width of the inner circumferential groove.

10. A tool for disassembling a drive assembly according to claim 1, comprising:
a ring-shaped base body with at least six threaded bores distributed circumferentially about a longitudinal axis , and
a number of screws corresponding to the number of threaded bores, which are arranged in the threaded bores so as to be adjustable in the radial direction relative to the longitudinal axis.

11. The tool according to claim 10, wherein the ring-shaped base body has a central opening, wherein the inner diameter of the central opening is larger than the outer diameter of the sun gear.

12. A method of disassembling the drive assembly according to claim 1 with a tool according to claim 10, comprising the steps of:12. A method of disassembling the drive assembly according to claim 1 with a tool according to claim 10, comprising the steps of:
arranging the ring-shaped base body of the tool on the hollow shaft,
aligning the base body relative to the hollow shaft so that the threaded bores are aligned with the radial bores,
screwing the screws into the radial bores to push the circlip radially inward out of the inner circumferential groove of the hollow shaft and to separate the hollow shaft from the connecting shaft in order to remove the sun gear.

13. The method according to claim 12, wherein the ring-shaped base body is pushed over the sun gear for being arranged on the hollow shaft.
